(19) United States
(12) Patent Application Publication
(10) Pub. No.: US 2004/0208786 A1
(43) Pub. Date: Oct. 21, 2004

(54) Autologous coagulant produced from anticoagulated whole blood

(76) Inventors: Sherwin V. Kevy, Brookline, MA (US); Sheryl Sullivan, Braintree, MA (US); May Jacobson, Wayland, MA (US); Lou Blasetti, Quincy, MA (US)

Correspondence Address: HESLIN ROTHENBERG FARLEY & MESITI PC, 5 COLUMBIA CIRCLE, ALBANY, NY, 12203, US

(21) Appl. No.: 10/765,694

(22) Filed: Jan. 27, 2004

Related U.S. Application Data
(60) Provisional application No. 60/442,974, filed on Jan. 27, 2003.

(51) Int. Cl. G01N 1/00

(52) U.S. Cl. 422/61; 436/17

(57) ABSTRACT

A method for the preparation of a stable autologous or homologous coagulant from whole blood is disclosed. The direct precipitation of anticoagulated whole blood obviates the need for a plasma isolation step with unexpected results. The autologous or homologous coagulant produced by the method of the present invention demonstrated clotting times equivalent to commercially available bovine thrombin and human thrombin preparations, with improved kinetics of growth factor release from activated platelets over preparations of bovine thrombin.

### CROSS-REFERENCE TO RELATED APPLICATIONS

The present application is a non-provisional application that claims priority to U.S. provisional application serial No. 60/442,974 filed Jan. 27, 2003, the contents of which are hereby incorporated by reference, in their entirety, into the present application.

### FIELD OF THE INVENTION

The present invention relates to a method for producing a fast-acting autologous or homologous coagulant from anticoagulated whole blood.

### BACKGROUND OF THE INVENTION

Thrombin, derived from human or animal plasma is an effective coagulant of blood, and blood derivatives (purified fibrinogen, platelet rich plasma (PRP), platelet concentrate (PC), platelet poor plasma (PPP)). It acts upon fibrinogen, converting it to fibrin, which results in the formation of a fibrin matrix. Clinical use of bovine thrombin (BT) as a hemostatic agent is common, while human plasma-derived thrombin is only licensed to be used in combination with human plasma-derived fibrin sealant, for example, TISSEEL® Fibrin Sealant (Baxter Corp.) as a topical hemostatic agent and wound sealant in a variety of surgical procedures.

Bovine-derived thrombin has been utilized for decades as a standard-of-care for achieving clinical hemostasis in the surgical setting. It has been used as a means to prepare a fibrin sealant derived from pooled solvent detergent treated human plasma. Bovine thrombin is also used to clot laboratory (e.g., blood bank) prepared cryoprecipitate and point-of-care-prepared autologous or homologous platelet rich plasma, platelet concentrate or platelet poor plasma (PRP, PC and PPP, respectively).

The risks associated with the use of bovine thrombin include the possibility of disease transmission (bovine spongiform encephalopathy, BSE) and the development of antibodies to human factor V. Although there are no reports in the literature of transmission of BSE from the clinical use of bovine thrombin, there have been reports of antibody development that resulted in abnormal bleeding times (1-5). Inhibitors to human Factor V have been reported following topical exposure to chromatographically purified bovine thrombin. (6). Exposure to topical bovine thrombin has resulted in the development of antibodies to multiple protein and carbohydrate antigens. These antibodies have been reported in 30% to 55% of exposed patients and are of a cardiolipin nature as well as antinuclear antibodies (7, 8).

As a result of the concerns associated with the use of bovine thrombin, alternative coagulants prepared from the patient's own blood (autologous) or donor blood (homologous) have been investigated.

To date, the present inventors have produced a procoagulant having a one to five minute clotting time, that has proven effective when combined with PRP or PPP and applied to hard tissue graft materials (for example, in autograft, allograft, xenograft and synthetic). The composition applied to these materials results in consolidation of the graft materials which provides for significantly improved handling characteristics and simplified transport to the surgical defect site. The resulting graft materials in this form can be shaped to the defect site and remain stabilized. The presence of certain proteins in PRP and PC also contributes to more rapid healing of the defect.

Although effective in the above indications, a procoagulant clotting time of 1 to 5 minutes may not be effective for certain soft tissue applications, resulting in a need for a non-bovine coagulant with a more rapid clotting time. Clot times of approximately 10 seconds (typical with bovine thrombin) are routinely needed to achieve hemostasis. Longer clotting times are less desirable and may be less effective in controlling capillary bleeding.

To date, investigation into the development of a non-bovine, fast acting coagulant has been focused on isolating the cellular components of blood and then applying various methods to isolate proteins from the blood plasma fractions. Methods such as cryoprecipitation, physico-chemical precipitation, the use of micro-filter technology, density gradient technology and the like are used. Plasma fractions have been isolated and characterized.

In addition, various commonly known precipitating agents, such as, for example, polyethylene glycol (PEG), ammonium sulfate and ethanol have also been investigated. Each of these agents has certain advantages in isolating particular proteins, while causing the partial precipitation of other proteins. Nonetheless, these precipitating agents have been utilized and applied to cell-free plasma in order to achieve the maximum effectiveness of the separation process.

Until recently, the primary focus has been on the use of various strengths of ethanol, e.g., 10% to 25%, applied to cell free plasma (see U.S. Pat. No. 6,274,090, for example, which discloses a method of preparing a stable thrombin component from plasma from a single donor.) Preparation of thrombin using this method is time consuming and requires numerous steps including the requirement to first prepare a plasma fraction from whole blood prior to contacting the plasma with ethanol.

While certain strengths of ethanol applied to plasma have provided improved clotting times, e.g., 5 to 15 seconds to clot PRP or PPP (U.S. Pat. No. 6,274,090), one hour after preparation of the composition, clotting time increased to greater than 25 seconds, and two hours after preparation, clotting time increased to greater than 40 seconds.

What is needed, therefore, is a method for preparing an autologous or homologous coagulant, wherein said method requires a small volume of whole blood, results in the production of a coagulant that results in a clot in less than twenty seconds; produces a coagulant that maintains its activity for more than 4 hours; and produces a coagulant that requires a total preparation time of less than sixty minutes.

### SUMMARY OF THE INVENTION

The present inventors have now discovered that by eliminating the plasma isolation step, and by adding a precipitating agent directly to anticoagulated whole blood, a human coagulant having rapid clotting times that are maintained by the composition for an extended period of time is obtained. The total time required for the preparation of the coagulant is thereby reduced by the amount of time required for isolation of the plasma fraction from whole blood.

Significantly, the performance efficacy of the coagulant produced by the method of the present invention is not diminished by the slight hemolysis that occurs as the result of eliminating the plasma isolation step. Moreover, without being held to any particular theory, it is now believed that the presence of red blood cells may actually contribute to cellular agglomeration and precipitation of the inhibitor proteins,

In one aspect, therefore, the present invention relates to a rapid method for the preparation of a fast-acting coagulant from anticoagulated whole blood, which method comprises obtaining a volume of anticoagulated whole blood from a donor; mixing said anticoagulated whole blood with a precipitating agent; incubating the mixture for a time sufficient for precipitation of the cellular and plasma components to occur and subsequently, separating the precipitate to obtain a supernatant wherein said supernatant contains a fast-acting coagulant.

In a related aspect, the invention relates to a rapid method for the preparation of an autologous coagulant from anticoagulated whole blood, which method comprises obtaining a volume of anticoagulated whole blood from the patient for whom the coagulant is being prepared; mixing said anticoagulated whole blood with a precipitating agent; incubating the mixture for a time sufficient for precipitation of cellular and specific plasma components to occur and subsequently, separating the precipitate obtained to obtain a supernatant wherein said supernatant contains an autologous or homologous coagulant.

The method of the present invention can be scaled to produce various volumes of coagulant as needed as well as from a relative small volume of whole blood, about 8 to 10 ml obtained from the patient or homologous donor. The whole blood is anticoagulated with an anticoagulant, such as ACD, optionally containing mannitol in a concentration of 5-10 mg/ml of ACD.

In another aspect, the invention relates to a method of preparing an autologous coagulant without the need for plasma isolation. The method of the present invention involves the direct precipitation of anticoagulated whole blood, as opposed to plasma previously separated from whole blood, with a precipitating agent, for example, ethanol.

In a related aspect, the invention relates to a human blood fraction produced by the method described above comprising 80-90% of prothrombin-thrombin proteins, no detectable fibrinogen and 20-30% of baseline levels of ATIII, Protein C and Protein S.

### BRIEF DESCRIPTION OF THE DRAWINGS

FIG. 1 is a graph depicting the correlation of the level of PDGF-AB released from a platelet concentrate blood sample activated with thrombin with platelet count for five donors.

FIG. 2 is a graph depicting the correlation of the level of TGF-β1 released from a platelet concentrate blood sample activated with thrombin with platelet count for five donors.

FIG. 3-7 are graphs depicting the growth factor release kinetics of PDGF-AB and TGF-β1 of five donor platelet concentrate samples activated with both bovine thrombin and autologous thrombin.

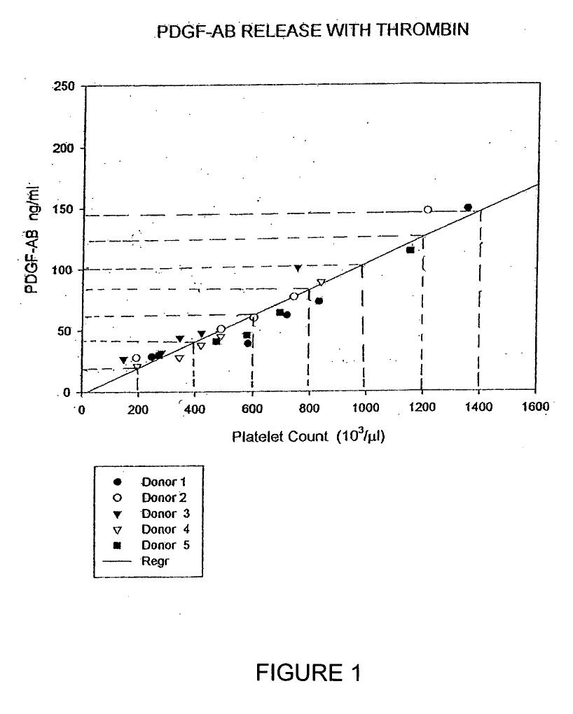

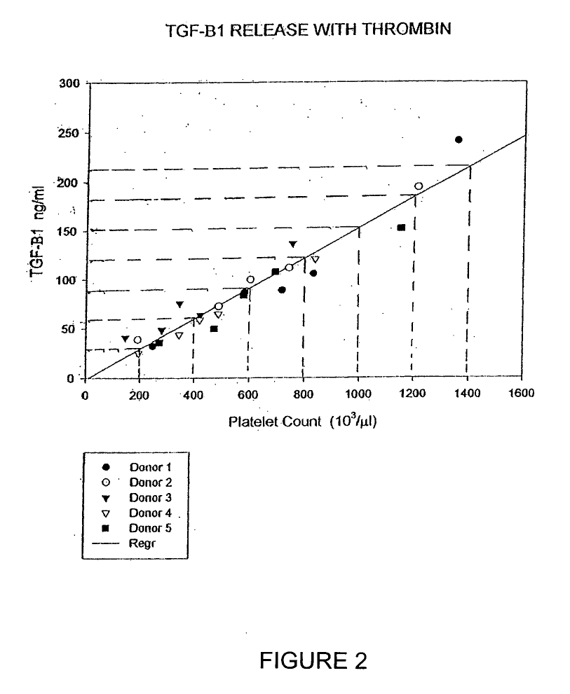

### DETAILED DESCRIPTION OF THE INVENTION

All patents, applications, publications, or other references that are listed herein are hereby incorporated by reference. In the description that follows, certain conventions will be followed as regards the use of terminology:

| | |
|---|---|
| ACD | acid-citrate-dextrose |
| CaCl₂ | calcium chloride |
| CPD | citrate-phosphate-dextrose |
| EDTA | ethylenediamine tetraacetic acid |
| ETOH | ethanol, ethyl alcohol |
| PEG | polyethylene glycol |
| PPP | platelet-poor plasma |
| PRP | platelet-rich plasma |
| PC | platelet concentrate |

The term “anticoagulant” refers to a substance capable of preventing whole blood from clotting.

The term “autologous blood” refers to a patient's own blood.

The term “homologous blood” refers to that obtained from a blood donor other than the individual for whom the coagulant is prepared.

The term “coagulant” refers to a substance capable of causing whole blood or a blood component (plasma, platelets) to form a clot.

The methodology for the isolation of an autologous coagulant in accordance with the present invention is based upon a modification of ethanol fractionation. In contrast to the standard or commonly used starting material, i.e., plasma or cryo-precipitate poor plasma, however, the process described utilizes a whole blood sample. Accordingly, the method of the present invention comprises:

a) obtaining a volume of anticoagulated whole blood from a donor;

b) mixing said anticoagulated whole blood with a precipitating agent;

c) incubating the mixture of b) for a time sufficient for precipitation of cellular and specific plasma components to occur;

d) separating the precipitate obtained in c) from the supernatant (usually by centrifugation and/or filtration); and

e) recovering the supernatant wherein the supernatant is used as a coagulant.

In one embodiment, a small volume of anticoagulated whole blood is obtained by drawing blood from the donor into a blood collection tube or syringe which contains an anticoagulant, for example, acid-citrate-dextrose. After thorough but gentle mixing, the anticoagulated whole blood is transferred to a clean glass or plastic tube and a precipitating agent, such as ethanol, is mixed with the anticoagulated whole blood. The resulting mixture is incubated at room temperature for a period of time sufficient for precipitation of the cellular and specific plasma components of the blood to occur, about 20-60 minutes. Sufficient precipitation will be evidenced by the formation of a viscous precipitate consisting of agglomerized cells and insoluble proteins.

The mixture is then centrifuged for about 5-30 minutes at 1,000-3,000×g to pack the precipitate at the bottom of the tube. Finally, the supernatant above the precipitate is removed from the tube; the supernatant being that fraction of the mixture that contains the desired coagulant.

In one embodiment, the volume of whole blood used to prepare the coagulant will be small, for example, as little as 8 to 10 ml. The blood is drawn into a blood collection tube (e.g. a VACUTAINER® tube) or syringe containing a non-heparin anticoagulant. Examples of anticoagulants that may be used in the invention include calcium ion-binding or sequestering anticoagulants, such as, citrate-phosphate-dextrose (CPD) or acid-citrate-dextrose (ACD), sodium citrate, and the like. Under typical circumstances, the preferred anticoagulants are acid-citrate-dextrose (ACD) and ACD/mannitol.

Typical precipitating agents will include, for example, polyethylene glycol, ammonium sulfate or ethanol, as well as such components as calcium chloride or magnesium chloride.

In one embodiment, ethanol is used as a precipitating agent. The final concentration of ethanol will preferably be between 10% and 25%. For an 8 to 10 ml starting whole blood volume, therefore, 1 to 2 ml of 100% or 95% ethanol is added to the whole blood.

Additionally between about 0.05 and 0.4 ml of a 10% solution of calcium chloride is added to the mixture of anticoagulated whole blood and precipitating agent. For example, in one embodiment, with a starting anticoagulated whole blood volume of 8 ml, a mixture of 1.6 ml ethanol and 0.1 ml of 10% CaCl₂ was used.

With respect to the time sufficient for precipitation of the cellular and specific plasma components to occur, precipitate may be expected to form in the tube within about 5 to 45 minutes.

In one embodiment, the initial volume of whole blood may be anticoagulated with a mixture of ACD and mannitol, with the concentration of mannitol being about 5-10 mg/1 ml ACD.

To illustrate the method of the present invention, the following examples are provided.

### EXAMPLE 1

A comparison of the relevant plasma protein levels in autologous thrombin and in a whole blood sample using radial immunodiffusion (RID) was performed. Whole blood was collected in a tube containing an ACD-mannitol anticoagulant. The anticoagulated whole blood was then incubated with 2 ml of a 95% ethanol solution for 30 minutes. The mixture was then centrifuged in the SMARTPREP™ system (Harvest Technologies, Plymouth, Mass.) simultaneously with preparation of a platelet concentrate. The supernatant containing thrombin is separated from the precipitated cellular and specific plasma components using a serum filter system, for example, a serum filter separator (e.g., Fisher Brand, Fisher Scientific, Rochester, N.Y.) or by using a syringe to aspirate the supernatant.

Platelet poor plasma was prepared as follows. Whole blood was collected into an ACD anticoagulant solution (Cytosol Laboratories, Braintree, Mass.) from the same donor that was used to prepare autologous thrombin. The blood sample was centrifuged and an aliquot of plasma was obtained for testing. The plasma aliquot was used as the baseline sample for radial immunodiffusion (RID) analysis.

Autologous thrombin (AT) was prepared as previously described. Basically, nine (9) milliliters of whole blood was collected into 1 ml ACD-mannitol anticoagulant (Cytosol Laboratories, Braintree, Mass.). Eight (8) milliliters of anticoagulated blood was incubated with a 1.7 ml ethanol-calcium chloride solution (Cytosol Laboratories, Braintree, Mass.) for 30 minutes at room temperature. The mixture was then centrifuged in the SMARTPREP® 2 system. The supernatant containing the autologous thrombin was separated from the precipitated proteins and red blood cells using a blood serum filter system. The resulting supernatant was analyzed by RID.

All RIDs were performed on 14 donors. The following proteins levels were analyzed: protein C, protein S, antithrombin III, albumin, fibrinogen, Factor XIII. A sample of PPP was analyzed to obtain baseline levels of the above proteins. A sample of the AT supernatant containing AT was analyzed for the levels of the proteins mentioned above to establish the rate of removal of these proteins as a result of the ethanol fractionation.

### Radial Immunodiffusion Procedure

RID plates were obtained from The Binding Site Ltd. (Birmingham UK) and used in accordance with manufacturers instructions. The RID plate was removed from the foil pouch, checked for damage and left open for 10-15 minutes at room temperature. Next a calibrator solution was mixed gently and diluted as needed. Control and test samples were diluted 1/10 prior to assay. The calibrator, control and test samples were mixed gently immediately before use.

The required number of wells were filled with 5 μL of the sample and allowed to diffuse for 30 minutes. The plates were stored flat at room temperature for at least 48 hours for albumin analysis, 72 hours for antithrombin III analysis, and 96 hours for Factor XIII, Proteins C and S, and Fibrinogen. Sample concentrations corresponding to each ring diameter were read directly from the RID Reference Table.

The results of the study are shown in Tables 1 and 2. The activity of the autologous thrombin preparations was confirmed by clotting platelet concentrates. The mean clotting time at both ratios was within our expected range. In three samples analyzed by an outside laboratory, 85% of the prothrombin was retained in the preparation. The fibrinogen was completely removed from the autologous thrombin preparations. Antithrombin III, a potent inhibitor of thrombin activation had a mean decrease of 79.86% ±2.6. The remaining antithrombin III level of 20% is considered in the range of clinical deficiency. There was no increase in AT III, Protein C and Protein S removal upon an additional four hours of incubation (data not shown). Table 1 provides a comparison of the protein levels of Protein C, Protein S and antithrombin III in autologous thrombin and the plasma of the whole blood sample from which it was prepared. Table 2 indicates the level of Factor XIII, albumin and fibrinogen in these same samples.

TABLE 1
Protein Levels in Plasma and Autologous Thrombin

| | | Clot Time | | | | | | | | | | |
|---|---|---|---|---|---|---|---|---|---|---|---|---|
| | | of PC | | Protein Levels in Plasma and Autologous Thrombin | | | | | | | | |
| | | (sec.) | | Protein C | | | Protein S | | | Antithrombin III | | |
| | | Ratio | | mg/L | | | mg/L | | | mg/L | | |
| Donor # | | 3:1 | 5:1 | b-line* | AT₀** | % rem.*** | b-line | AT₀ | % rem. | b-line | AT₀ | % rem. |
| 500 | ♂ | 7 | 7 | 2.95 | 1.92 | 35% | 22.5 | 14.7 | 35% | 284 | 72 | 75% |
| 500 | | 10 | 11 | | | | | | | | | |
| 501 | ♀ | 8 | 8 | 3.47 | 2.09 | 40% | 19.4 | 13.1 | 32% | 295 | 72 | 76% |
| 501 | | 9 | 9 | | | | | | | | | |
| 504 | ♀ | 21 | 26 | 3.05 | 1.83 | 40% | 18.8 | 11.5 | 39% | 337 | 54 | 84% |
| 504 | | 23 | 28 | | | | | | | | | |
| 505 | ♂ | 6 | 8 | 4.15 | 2.65 | 36% | 19.4 | 16.4 | 15% | 358 | 66 | 82% |
| 505 | | 7 | 9 | | | | | | | | | |
| 506 | ♂ | 26 | 24 | 3.4 | 2.09 | 39% | 16.4 | 9.06 | 45% | 337 | 66 | 80% |
| 506 | | 17 | 28 | | | | | | | | | |
| 508 | ♀ | 7 | 11 | 4.26 | 2.55 | 40% | 15.3 | 7.67 | 50% | 295 | 66 | 78% |
| 508 | | 7 | 9 | | | | | | | | | |
| 510 | ♀ | 8 | 11 | 4.26 | 2.55 | 40% | 18.8 | 12 | 36% | 326 | 60 | 82% |
| 510 | | 9 | 11 | | | | | | | | | |
| 511 | ♂ | 7 | 8 | 4.03 | 2.46 | 39% | 20.6 | 14.7 | 29% | 403 | 78.5 | 81% |
| 511 | | 7 | 8 | | | | | | | | | |
| 516 | ♂ | 10 | 14 | 3.05 | 1.92 | 37% | 20.6 | 13.1 | 36% | 227 | 42.3 | 81% |
| 516 | | 10 | 13 | | | | | | | | | |
| 517 | ♀ | 28 | 28 | 4.26 | 2.75 | 35% | 21.9 | 13.1 | 40% | 337 | 66 | 80% |
| 517 | | 20 | 26 | | | | | | | | | |
| 520 | ♀ | 14 | 21 | 4.5 | 2.95 | 34% | 18.2 | 10 | 45% | 337 | 66 | 80% |
| 520 | | 15 | 20 | | | | | | | | | |
| 522 | ♀ | 10 | 10 | 3.8 | 2 | 47% | 18.2 | 12.6 | 30% | 305 | 66 | 78% |
| 522 | | 11 | 8 | | | | | | | | | |
| 523 | ♂ | 18 | 23 | 3.58 | 2.32 | 35% | 19.4 | 13.1 | 32% | 295 | 66 | 78% |
| 523 | | 19 | 18 | | | | | | | | | |
| 524 | ♂ | 28 | 34 | 3.58 | 2.09 | 42% | 19.4 | 11 | 43% | 358 | 60 | 83% |
| 524 | | 30 | 23 | | | | | | | | | |
| | Mean | 14.00 | 16.21 | 3.74 | 2.30 | 38.50% | 19.21 | 12.29 | 36.21% | 321.00 | 64.34 | 79.86% |
| | STDev | 7.61 | 8.30 | 0.52 | 0.35 | 3.50% | 1.91 | 2.33 | 8.73% | 42.06 | 8.63 | 2.60% |

*Baseline level (i.e. plasma sample)
**Level in autologous thrombin.
***Percentage of baseline level removed.

TABLE 2
Protein Levels in Plasma and Autologous Thrombin

| | | Clot Time | | | | | | | | | | |
|---|---|---|---|---|---|---|---|---|---|---|---|---|
| | | of PC | | Protein Levels in Plasma and Autologous Thrombin | | | | | | | | |
| | | (sec.) | | Factor XIII | | | Albumin | | | Fibrinogen | | |
| | | Ratio | | mg/L | | | g/dL | | | mg/dL | | |
| Donor # | | 3:1 | 5:1 | b-line* | AT₀** | % rem.*** | b-line | AT₀ | % rem. | b-line | AT₀ | % rem. |
| 500 | Male | 7 | 7 | 14.1 | 6.34 | 55% | 3.64 | 2.46 | 32% | 301 | 0 | 100% |
| 500 | Male | 10 | 11 | | | | | | | | | |
| 501 | Female | 8 | 8 | 13.4 | 6 | 55% | 3.64 | 2.65 | 27% | 503 | 0 | 100% |
| 501 | Female | 9 | 9 | | | | | | | | | |
| 504 | Female | 21 | 26 | 14.7 | 6.88 | 53% | 3.58 | 2.75 | 33% | 268 | 0 | 100% |
| 504 | Female | 23 | 28 | | | | | | | | | |
| 505 | Male | 6 | 8 | 15.4 | 6.88 | 55% | 3.36 | 2.00 | 40% | 397 | 0 | 100% |
| 505 | Male | 7 | 9 | | | | | | | | | |
| 506 | Male | 26 | 24 | 15.4 | 6.88 | 55% | 3.75 | 2.65 | 29% | 216 | 0 | 100% |
| 506 | Male | 17 | 28 | | | | | | | | | |
| 508 | Female | 7 | 11 | 15.4 | 9.72 | 37% | 2.95 | 2.09 | 29% | 335 | 0 | 100% |
| 508 | Female | 7 | 9 | | | | | | | | | |
| 510 | Female | 8 | 11 | 14.7 | 8.55 | 42% | 3.36 | 2.27 | 32% | 347 | 0 | 100% |
| 510 | Female | 9 | 11 | | | | | | | | | |
| 511 | Male | 7 | 8 | 16.1 | 7.99 | 50% | 3.36 | 2.65 | 21% | 360 | 0 | 100% |
| 511 | Male | 7 | 8 | | | | | | | | | |
| 516 | Male | 10 | 14 | 14.1 | 6.88 | 51% | 4.15 | 2.22 | 47% | 422 | 0 | 100% |
| 516 | Male | 10 | 13 | | | | | | | | | |
| 517 | Female | 28 | 28 | 14.7 | 9.13 | 38% | 3.26 | 2.36 | 28% | 301 | 0 | 100% |
| 517 | Female | 20 | 26 | | | | | | | | | |
| 520 | Female | 14 | 21 | 12.8 | 7.99 | 38% | 3.58 | 2.55 | 29% | 289 | 0 | 100% |
| 520 | Female | 15 | 20 | | | | | | | | | |
| 522 | Female | 10 | 10 | 14.1 | 6.88 | 51% | 4.15 | 2.55 | 39% | 301 | 0 | 100% |
| 522 | Female | 11 | 8 | | | | | | | | | |
| 523 | Male | 18 | 23 | 10.9 | 8.55 | 22% | 3.58 | 2.55 | 29% | 324 | 0 | 100% |
| 523 | Male | 19 | 18 | | | | | | | | | |
| 524 | Male | 28 | 34 | 14.7 | 7.43 | 49% | 3.69 | 2.46 | 24% | 257 | 0 | 100% |
| 524 | Male | 30 | 23 | | | | | | | | | |
| | Mean | 14.00 | 16.21 | 14.32 | 7.58 | 46.50% | 3.58 | 2.44 | 31.36% | 330.07 | 0 | 100% |
| | STDev | 7.61 | 8.30 | 1.31 | 1.10 | 9.79% | 0.32 | 0.23 | 6.77% | 73.64 | 0.00 | 0% |

*Baseline level (i.e. plasma sample)
**Level in autologous thrombin.
***Percentage of baseline level removed.

A supernatant, therefore, obtained in accordance with the method of the present invention contains 80-90% of the prothrombin-thrombin proteins. There is no detectable fibrinogen in the supernatant, and only 20-30% of the baseline levels of ATIII, Protein C and Protein S.

Hemoglobin Determination of the Supernatant

Ethanol concentrations greater than six percent can produce hemolysis in a whole blood sample. As previously mentioned, mannitol was added to the anticoagulant to reduce micro vesicle formation and lessen the hemolysis resulting from the introduction of ethanol.

As shown in Table 3 the mean total hemoglobin in the autologous thrombin preparation was 69 mg. This corresponds to a mean percent hemolysis of 8% which is insignificant for topical application.

TABLE 3

Total Hemoglobin (mg)

| Donor # | Whole Blood | Autologous Thrombin |
|---|---|---|
| 650 | 832 | 84 |
| 651 | 704 | 68 |
| 652 | 872 | 25 |
| 653 | 1008 | 96 |
| 654 | 880 | 72 |
| Mean | 859.20 | 69.00 |
| STDev | 109.05 | 26.93 |

Determination of Residual Ethanol Levels

The percent ethanol (v/v) was measured by a certified testing laboratory (Chemic Laboratories, Canton, Mass.). The products tested included: the plasma from the whole blood sample from which autologous thrombin was made, the autologous thrombin product, and the supernatant obtained following the clotting of a platelet concentrate. The latter product, platelet gel would contain the level of ethanol that would be present following topical application.

Clots were formed in platelet concentrate using autologous thrombin as the clot activator. Samples of PPP from whole blood, AT supernatant and clot releasate were obtained for testing as described above. The tests were performed on five donors.

0.5 ml of PC was added to 12×75 mm Borosilicate glass culture tubes. AT was added in the ratio of 1:3 or 1:5 using calibrated pipettes. The tube was tilted back and forth until a solid clot formed. The clot was then centrifuged to obtain the supernatant.

Ethanol analyses were performed by Chemic Laboratories, Canton, Mass. The results are shown in Table 4. The trace amounts observed in the whole blood sample was obviously the result of the alcohol used to prepare the phlebotomy site. The levels determined in the autologous thrombin and platelet gel are within the predicted parameters.

TABLE 4
% Ethanol (v/v) Present in Autologous Thrombin and its Product

| | | Autologous | |
|---|---|---|---|
| | Whole Blood | Thrombin | Platelet Gel |
| Donor # | % Ethanol | % Ethanol | % Ethanol |
| 650 | 0.00035 | 13 | 3.3 |
| 651 | 0.00049 | 12 | 3.15 |
| 652 | 0.0017 | 14 | 3.2 |
| 653 | 0.0015 | 13 | 3.15 |
| 654 | 0.00116 | 12 | 2.75 |
| Mean | 0.00104 | 12.8 | 3.11 |
| STDev | 0.000600042 | 0.836660027 | 0.21035684 |

Thus, when the coagulant is combined with a platelet concentrate to produce a gel in vitro, the residual ethanol level is less than 4%. This residual concentration is further substantially reduced when applied to a wound site in vivo.

Comparison of Clotting Times of Platelet Concentrate and Platelet Poor Plasma by Autologous Thrombin

In vitro laboratory clotting time studies were performed to validate coagulant efficacy. Clotting times were performed on platelet concentrate and platelet poor plasma using autologous thrombin to initiate clotting. All testing was performed on 14 donors. Clotting times were performed in duplicate. The individual performing the test and the individual timing/recording the clotting times work independently.

Clot testing is performed at four time points following centrifugation: time zero immediately following decanting and recovery of the AT, two hours, four hours, and six hours following preparation of autologous thrombin. Briefly, 0.5 ml of PC was added to 12×75 mm borosilicate glass culture tubes. AT in the ratio of 1:3 or 1:5 was added ton the tube containing the PC using calibrated pipettes. The timer was started immediately as the AT was added. The tube was tilted back and forth until a solid clot formed. The timer was stopped and the clotting time recorded. The procedure was repeated at the indicated time intervals.

The clotting times of a platelet concentrate by autologous thrombin are shown in Table 5.

TABLE 5
Clotting Time (in sec.) of a platelet concentrate with AT

| | | Zero | | Two | | Four | | Six | |
|---|---|---|---|---|---|---|---|---|---|
| | | Time* | | Hours | | Hours | | Hours | |
| | | Clot Time | | Clot Time | | Clot Time | | Clot Tim | |
| | | in sec | | in sec | | in sec | | in sec | |
| | | Ratio | | Ratio | | Ratio | | Ratio | |
| # | | 3:1 | 5:1 | 3:1 | 5:1 | 3:1 | 5:1 | 3:1 | 5:1 |
| 500 | ♂ | 7 | 7 | 8 | 10 | 8 | 9 | | |
| 500 | | 10 | 11 | 8 | 11 | 8 | 10 | | |
| 501 | ♀ | 8 | 8 | 9 | 7 | 7 | 12 | | |
| 501 | | 9 | 9 | 9 | 10 | 7 | 9 | | |
| 504 | ♀ | 21 | 26 | 12 | 11 | 14 | 17 | 10 | 15 |
| 504 | | 23 | 28 | 9 | 15 | 10 | 16 | 13 | 17 |
| 505 | ♂ | 6 | 8 | 8 | 10 | 10 | 7 | 7 | 9 |
| 505 | | 7 | 9 | 9 | 11 | 8 | 8 | 8 | 9 |
| 506 | ♂ | 26 | 24 | 8 | 12 | 13 | 12 | 9 | 1 |
| 506 | | 17 | 28 | 10 | 11 | 10 | 14 | 11 | 12 |
| 508 | ♀ | 7 | 11 | 8 | 10 | 8 | 15 | 8 | 10 |
| 508 | | 7 | 9 | 7 | 10 | 8 | 12 | 9 | 11 |
| 510 | ♀ | 8 | 11 | 10 | 15 | 7 | 16 | 13 | 17 |
| 510 | | 9 | 11 | 11 | 11 | 12 | 17 | 12 | 18 |
| 511 | ♂ | 7 | 8 | 7 | 9 | 8 | 11 | 7 | 8 |
| 511 | | 7 | 8 | 7 | 10 | 6 | 8 | 7 | 8 |
| 516 | ♂ | 10 | 14 | 10 | 11 | 11 | 17 | 11 | 14 |
| 516 | | 10 | 13 | 9 | 12 | 11 | 12 | 9 | 15 |
| 517 | ♀ | 28 | 28 | 9 | 15 | 11 | 14 | 10 | 16 |
| 517 | | 20 | 26 | 10 | 10 | 9 | 13 | 10 | 15 |
| 520 | ♀ | 14 | 21 | 8 | 11 | 13 | 14 | 7 | 10 |
| 520 | | 15 | 20 | 8 | 13 | 9 | 11 | 9 | 12 |
| 522 | ♀ | 10 | 10 | 7 | 11 | 9 | 12 | 11 | 17 |
| 522 | | 11 | 8 | 12 | 12 | 9 | 14 | 10 | 17 |
| 523 | ♂ | 18 | 23 | 10 | 10 | 10 | 11 | 13 | 17 |
| 523 | | 19 | 18 | 8 | 10 | 12 | 10 | 12 | 19 |
| 524 | ♂ | 28 | 34 | 10 | 11 | 9 | 10 | 9 | 12 |
| 524 | | 30 | 23 | 9 | 10 | 10 | 12 | 9 | 13 |
| | Mean | 10.0 | 12.0 | 9.0 | 11.0 | 9.0 | 12.0 | 9.5 | 13.5 |
| | Lower | 8.0 | 9.0 | 8.0 | 10.0 | 8.0 | 11.0 | 9.0 | 10.0 |
| | limit | | | | | | | | |
| | 95% Cl | | | | | | | | |
| | Upper | 17.0 | 21.0 | 9.0 | 11.0 | 10.0 | 14.0 | 11.0 | 16.0 |
| | limit | | | | | | | | |
| | 95% Cl | | | | | | | | |

*Zero time = immediately following preparation

There was no significant difference in the clotting time of the two ratios at zero time and six hours. The differences in the clotting time of the two ratios were significant at two hours (p=0.004) and four hours (p=0.013).

More significant is the fact that at a ratio of 3:1, the clotting times at two, four and six hours are significantly shorter (p=0.001) than at zero time. As shown in Table 6, at a 3:1 ratio, 28.75% of the clotting times are 20 seconds or greater at zero time and only 50% are 10 seconds or less. At the other time intervals all clotting times were less than 20 seconds at both ratios: using a 3:1 ration, 64-85% of the clotting times were 10 seconds or less. This compares favorably with the observed bovine clotting time of four to six seconds, performed simultaneously in these studies.

TABLE 6
Distribution of Clotting Times of a Platelet Concentrate
by Autologous Thrombin

| Clotting time | Zero Time | | Two Hours | | Four Hours | | Six Hours | |
|---|---|---|---|---|---|---|---|---|
| intervals | 3:1 | 5:1 | 3:1 | 5:1 | 3:1 | 5:1 | 3:1 | 5:1 |
| ≦10 sec. | 50.00% | 42.86% | 85.71% | 28.57% | 64.29% | 21.43% | 66.66% | 25.00% |
| 10.5-19.5 sec. | 21.43% | 14.28% | 14.29% | 71.43% | 36.71% | 78.57% | 33.33% | 75.00% |
| ≧20 sec. | 28.57% | 42.86% | 0.00% | 0.00% | 0.00% | 0.00% | 0.00% | 0.00% |

The results of the clotting times of platelet poor plasma by autologous thrombin, although slightly longer, parallel those obtained with a platelet concentrate (Table 7). There is no significant difference between the two ratios at zero time (p=0.695). At a 3:1 ratio the clotting times at two and four hours are significantly shorter (p=0.0013) than at zero time. While there is a slight redistribution of clotting times for platelet poor plasma, the clotting times are similar to those of the platelet concentrate (Table 8).

TABLE 7
Clotting Times (sec.) of Platelet Poor Plasma by Autologous Thrombin

| | | Zero | | Two | | Four | | Six | |
|---|---|---|---|---|---|---|---|---|---|
| | | Time | | Hours | | Hours | | Hours | |
| | | Ratio | | Ratio | | Ratio | | Ratio | |
| Donor # | Gender | 3:1 | 5:1 | 3:1 | 5:1 | 3:1 | 5:1 | 3:1 | 5:1 |
| 500 | Male | 9 | 14 | 8 | 12 | 7 | 9 | | |
| 500 | Male | 10 | 11 | 8 | 11 | 9 | 12 | | |
| 501 | Female | 10 | 10 | 12 | 14 | 8 | 13 | | |
| 501 | Female | 10 | 10 | 10 | 13 | 9 | 14 | | |
| 504 | Female | 17 | 31 | 11 | 18 | 14 | 20 | 14 | 20 |
| 504 | Female | 16 | 31 | 12 | 15 | 14 | 19 | 22 | 20 |
| 505 | Male | 10 | 10 | 9 | 11 | 9 | 11 | 7 | 13 |
| 505 | Male | 9 | 11 | 10 | 12 | 9 | 11 | 9 | 14 |
| 506 | Male | 15 | 17 | 11 | 14 | 12 | 15 | 10 | 14 |
| 506 | Male | 17 | 19 | 11 | 13 | 12 | 16 | 11 | 16 |
| 508 | Female | 8 | 11 | 9 | 13 | 9 | 14 | 11 | 13 |
| 508 | Female | 7 | 13 | 8 | 12 | 9 | 10 | 12 | 14 |
| 510 | Female | 12 | 13 | 12 | 17 | 16 | 20 | 13 | 22 |
| 510 | Female | 11 | 13 | 11 | 14 | 13 | 18 | 15 | 20 |
| 511 | Male | 8 | 11 | 9 | 9 | 8 | 13 | 7 | 9 |
| 511 | Male | 6 | 10 | 8 | 12 | 9 | 13 | 7 | 10 |
| 516 | Male | 13 | 17 | 12 | 14 | 13 | 16 | 16 | 17 |
| 516 | Male | 14 | 13 | 12 | 17 | 10 | 18 | 13 | 18 |
| 517 | Female | 24 | 28 | 8 | 16 | 11 | 18 | 12 | 17 |
| 517 | Female | 26 | 24 | 10 | 17 | 10 | 16 | 13 | 19 |
| 520 | Female | 17 | 21 | 9 | 15 | 14 | 14 | 13 | 14 |
| 520 | Female | 18 | 19 | 10 | 16 | 11 | 14 | 13 | 15 |
| 522 | Female | 9 | 11 | 9 | 13 | 10 | 14 | 10 | 15 |
| 522 | Female | 9 | 10 | 11 | 12 | 11 | 16 | 11 | 19 |
| 523 | Male | 22 | 22 | 12 | 16 | 12 | 17 | 15 | 20 |
| 523 | Male | 20 | 20 | 11 | 13 | 13 | 15 | 15 | 20 |
| 524 | Male | 29 | 31 | 9 | 11 | 11 | 15 | 11 | 17 |
| 524 | Male | 28 | 24 | 11 | 15 | 12 | 16 | 12 | 16 |
| | Median | 12.5 | 13.5 | 10.0 | 13.5 | 11.0 | 15.0 | 12.0 | 16.5 |
| | Lower limit 95% Cl | 10.0 | 11.0 | 9.0 | 12.0 | 9.0 | 14.0 | 11.0 | 14.0 |
| | Upper limit 95% Cl | 17.0 | 19.0 | 11.0 | 15.0 | 12.0 | 16.0 | 13.0 | 19.0 |

TABLE 8
Distribution of clotting times of platelet poor plasma by autologous thrombin

| Clotting time | Zero Time | | Two Hours | | Four Hours | | Six Hours | |
|---|---|---|---|---|---|---|---|---|
| intervals | 3:1 | 5:1 | 3:1 | 5:1 | 3:1 | 5:1 | 3:1 | 5:1 |
| ≦10 sec. | 42.86% | 7.14% | 57.14% | 0.00% | 35.71% | 0.00% | 16.67% | 8.33% |
| 10.5-19.5 sec. | 35.71% | 57.14% | 42.86% | 100.00% | 64.29% | 100.00% | 83.33% | 66.67% |
| ≧20 sec. | 21.43% | 35.72% | 0.00% | 0.00% | 0.00% | 0.00% | 0.00% | 25.00% |

Determination of Thrombin Equivalence

Comparison of the Clotting Times of Platelet Concentrate

The potency of autologous thrombin compared to bovine thrombin was examined utilizing a platelet concentrate and three levels of human fibrinogen as the evaluation material. Bovine thrombin (BT) was prepared as follows. 5.0 ml of a 10% CaCl₂ solution was injected into a 5,000 unit vial of freeze-dried thrombin and gently inverted. BT was then was then serially diluted to concentrations of 1000, 500, 250, 125 and 62.5 units/ml. BT was subsequently added to a platelet concentrate in the ratio of 1:10.

Clotting times were determined as described above. Table 9 compares the clotting time of platelet concentrates ranging in levels of 466×10³ μl to 1428×10³ μl. The mean clotting time obtained with autologous thrombin was 9.17±1.7 sec. At a 3:1 ratio of platelet concentrate to autologous thrombin. A comparable mean clotting time (9.00±1.7 sec) was obtained with bovine thrombin at a concentration of 250 u/ml. In view of the fact that the bovine thrombin studies were performed at a 10:1 ration (platelet concentrate to thrombin) this would indicate that the autologous thrombin was equivalent to a bovine thrombin level of 25 units/ml. As shown in Table 10, the clotting times with autologous thrombin at a 5:1 ratio (10.83 sec) are in a similar range.

TABLE 9
Clotting Times (sec) of Platelet Concentrate Using Bovine
and Autologous Thrombin

| | | Platelet | | | Autologous | | Bovine Thrombin | | | | |
|---|---|---|---|---|---|---|---|---|---|---|---|
| | | Counts (10³/μL) | | | Thrombin | | (units/ml) 10:1 | | | | |
| Donor # | Gender | EDTA | PC | ×b-line | 3:1 | 5:1 | 1000 | 500 | 250 | 125 | 62.5 |
| 528 | Male | 254 | 1095 | 4.80 | 11 | 10 | 4 | 7 | 9 | 11 | 29 |
| | | | | | 8 | 12 | 3 | 8 | 8 | 12 | 28 |
| 529 | Male | 301 | 1410 | 5.20 | 9 | 12 | 4 | 5 | 7 | 11 | 21 |
| | | | | | 8 | 10 | 6 | 7 | 8 | 12 | 23 |
| 530 | Female | 260 | 1010 | 4.30 | 9 | 10 | 4 | 10 | 10 | 16 | 23 |
| | | | | | 8 | 8 | 4 | 11 | 9 | 12 | 27 |
| 616 | Female | 211 | 1146 | 6.00 | 13 | 13 | 4 | 8 | 10 | 12 | 26 |
| | | | | | 12 | 15 | 4 | | | | 22 |
| 617 | Female | 167 | 726 | 4.80 | 9 | 9 | 4 | 9 | 9 | 15 | 26 |
| | | | | | 9 | 9 | 5 | | | | |
| 618 | Male | 222 | 1246 | 6.20 | 9 | 11 | 5 | 9 | 8 | 16 | 27 |
| | | | | | 8 | 12 | 5 | | | | 25 |
| 623 | Male | 177 | 792 | 5.00 | 9 | 10 | 4 | 8 | 14 | 17 | 18 |
| | | | | | 8 | 10 | | | 9 | 14 | 18 |
| 624 | Male | 169 | 466 | 3.10 | 9 | 13 | 5 | 5 | 7 | 17 | 26 |
| | | | | | 9 | 11 | | | 10 | 15 | 25 |
| 626 | Male | 266 | 1428 | 6.00 | 7 | 10 | 5 | 5 | 7 | 17 | 26 |
| | | | | | 8 | 7 | | | 10 | 15 | 25 |
| | Mean | 225.22 | 1035.44 | 5.04 | 9.17 | 10.83 | 4.40 | 7.67 | 9.00 | 14.13 | 24.41 |
| | STDev | 48.13 | 322.96 | 0.98 | 1.70 | 2.17 | 0.74 | 1.97 | 1.77 | 2.26 | 3.18 |

Clotting Times of Different Levels of Purified Human Fibrinogen

Platelet concentrate (PC) and platelet poor plasma (PPP) were prepared as follows using the SmartPReP®2 system in accordance with the instructions for use. PPP was removed with a 30 ml syringe with a spacer set to leave a 7 ml volume in the Plastic Disposable (PD), and was transferred to a 50 ml tube. The total volume was measured.

The platelets were resuspended in the 7 ml volume, transferred into labeled 50 ml tubes and the total volume measured. A 0.5 ml sample of PC and PPP was transferred into cryogenic vials for CBC analysis.

Bovine thrombin (BT obtained from Jones Pharma Inc., Middleton Wis.) was prepared for use by injecting 5.0 ml of the 10% CaCl₂ to a 5000 unit vial of desiccated thrombin. Five dilutions of BT were prepared: 1000, 500, 250, 125, and 62.5 units/ml. BT was added to fibrinogen in the ratio of 1:10, with the volume of fibrinogen equaling 0.5 ml.

Autologous thrombin (AT) was prepared as follows. Nine (9) ml of whole blood was collected into 1 ml ACD-mannitol anticoagulant. Eight (8) ml of anticoagulated blood was incubated with a 1.7 ml ethanol-calcium chloride solution for 45 minutes. The mixture was then centrifuged in the SmartPReP®2 system simultaneously with the preparation of a platelet concentrate. The supernatant containing the thrombin was separated from the precipitated proteins and red blood cells using a separation tube. AT was added to fibrinogen in the ratio of 1:3 and 1:5.

Human fibrinogen was obtained in the dessicated form from Sigma Biologicals (St. Louis, Mo.) and was analyzed to be 91% clottable. The fibrinogen was tested at three levels of 600, 300 and 150 mg/dl in distilled water.

Clotting times were performed on fibrinogen with autologous thrombin and bovine thrombin acting as clotting initiators. Autologous thrombin was prepared from the nine whole blood samples. As with the other clotting studies described above, the individual performing the test and the individual timing/recording the clotting time worked independently.

### Fibrinogen Test

0.5 ml of fibrinogen was delivered using calibrated pipette into a 12×75 mm borosilicate glass culture tubes. AT was added in the 1:3 or 1:5 ratio using calibrated pipettes. The timer was started when total volume of AT was added. The glass tube was tilted back and forth until a solid clot formed. The timer was then stopped and the clotting time recorded. The above test was repeated using the bovine thrombin/ CaCl₂ activator in place of autologous thrombin.

The mean fibrinogen level of a 100 consecutive surgical patients at the Children's Hospital and the Brigham and Women's Hospital (Boston, Mass.) was found to be 268±27 mg/dL. Fibrinogen is an acute phase reactant; levels of 600-800 mg/dL are not uncommon in patients with chronic clinical conditions (i.e. chronic venous or diabetic ulcers, arthritis, herniated discs). That was the basis for the fibrinogen levels chosen in this study.

As shown in Table 10 the clotting time of the three levels of fibrinogen was significantly greater than that observed with a platelet concentrate using autologous thrombin at both a 3:1 and 5:1 ratios. This was not unexpected since platelets play an integral role in both in vitro and in vivo clot formation (7).

TABLE 10
Clotting times in seconds of varying levels of fibrinogen by autologous
thrombin.

| | | | | Autologous Thrombin | | | | | |
|---|---|---|---|---|---|---|---|---|---|
| | | | | 3:1 | | | 5:1 | | |
| | Control Values* | | PC plt. Count | Fibrinogen mg/dl | | | Fibrinogen mg/dl | | |
| Donor # | 3:1 | 5:1 | (10³/μL) | 600 | 300 | 150 | 600 | 300 | 150 |
| 528 | 9 | 11 | 1,095 | 12 | 23 | 30 | ND** | ND | ND |
| | | | | 12 | 23 | 29 | | | |
| 529 | 8.5 | 11 | 1410 | 13 | 19 | 23 | ND | ND | ND |
| | | | | 16 | 18 | 26 | | | |
| 530 | 8.5 | 9 | 1010 | 10 | 13 | 14 | ND | ND | ND |
| | | | | 8 | 14 | 11 | | | |
| 616 | 12.5 | 14 | 1,146 | 13 | 14 | 13 | 19 | 24 | 24 |
| | | | | 13 | 15 | 16 | 21 | 18 | 43 |
| 617 | 9 | 9 | 726 | 17 | 12 | 17 | 19 | 18 | 27 |
| | | | | 17 | 13 | 23 | 17 | 18 | 24 |
| 618 | 8.5 | 11.5 | 1,246 | 18 | 9 | 16 | 18 | 17 | 25 |
| | | | | 15 | 10 | 15 | 15 | 14 | 27 |
| 623 | 8.5 | 10 | 792 | 12 | 9 | 14 | 15 | 20 | 32 |
| | | | | 12 | 12 | 20 | 16 | 17 | 30 |
| 624 | 9 | 12 | 466 | 11 | 13 | 23 | 19 | 21 | 20 |
| | | | | 11 | 17 | 28 | 15 | 18 | 24 |
| 626 | 7.5 | 8.5 | 1,428 | 13 | 15 | 18 | 12 | 15 | 25 |
| | | | | 12 | 13 | 18 | 13 | 18 | 24 |
| Mean | 9.00 | 10.67 | 1035.44 | 13.06 | 14.56 | 19.67 | 16.58 | 18.17 | 27.08 |
| STDev | 1.39 | 1.75 | 322.96 | 2.62 | 4.10 | 5.85 | 2.71 | 2.62 | 5.90 |

This same pattern was observed when evaluating the clotting time of different levels of fibrinogen by varying dilutions of bovine thrombin. The clotting time of a fibrinogen level of 600 mg/dL by 125 u/mL of bovine thrombin was 13.75±0.9 sec. and at 300 mg/dL was 16.25±3.8 sec. These values are similar to the results observed when autologous thrombin at a 3:1 ratio was used to clot fibrinogen levels of 600 and 300 mg/dL (Table 11).

TABLE 11
Bovine Thrombin 10:1

| 1000 units/ml | | | 500 units/ml | | | 250 units/ml | | | 125 units/ml | | | 62.5 units/ml | | |
|---|---|---|---|---|---|---|---|---|---|---|---|---|---|---|
| Fibrinogen mg/dl | | | Fibrinogen mg/dl | | | Fibrinogen mg/dl | | | Fibrinogen mg/dl | | | Fibrinogen mg/dl | | |
| 600 | 300 | 150 | 600 | 300 | 150 | 600 | 300 | 150 | 600 | 300 | 150 | 600 | 300 | 150 |
| 5 | 5 | 7 | 7 | 6 | 7 | 12 | 9 | 12 | 13 | 12 | 14 | 20 | 23 | 29 |
| 4 | 4 | 9 | 7 | 7 | 9 | 9 | 8 | 11 | 15 | 14 | 15 | 22 | 24 | 33 |
| 5 | 8 | 12 | 6 | 9 | 21 | 9 | 10 | 34 | 14 | 20 | 29 | 16 | 21 | 45 |
| 6 | 4 | 9 | 6 | 8 | 19 | 10 | 13 | 22 | 13 | 19 | 26 | 18 | 27 | 38 |
| 5 | 5.25 | 9.25 | 6.5 | 7.5 | 14 | 10 | 10 | 19.75 | 13.75 | 16.25 | 21 | 19 | 23.75 | 36.25 |
| 0.816 | 1.893 | 2.062 | 0.577 | 1.291 | 7.024 | 1.414 | 2.16 | 10.72 | 0.957 | 3.862 | 7.616 | 2.582 | 2.5 | 6.898 |

The clotting time (8-12 seconds) using the autologous thrombin (AT) produced in accordance with the method of the present invention was equivalent to our previous studies using bovine thrombin (BT) at 100 u/ml and human thrombin at 500 u/ml.

Tissue Culture Studies

It has been shown by Slater et al that platelet concentrates exert a stimulatory effect on human fetal osteoblast-like cells and maintain their differentiated function (10). It has also been demonstrated that high levels of platelet concentrate releasate enhances proliferation of human mesenchymal stem cells (hMSCs)(11). The purpose of this study was to evaluate whether the residual alcohol in the autologous thrombin combined with platelet concentrate inhibits the growth of cultured human fibroblast cells and hMSCs.

Platelet concentrates were clotted with autologous thrombin or bovine thrombin in inserts placed above the culture wells plated with human fibroblasts in a co-culture system. The cells were incubated for three and five days.

Plated hMSCs were incubated with platelet concentrate releasate. The releasate was made from clots activated with AT or BT and incubated for three and five days. The releasate was added directly to the media and incubated with the cells.

A platelet concentrate was prepared using the SMARTPREP®2 system in accordance with the instructions for use. The platelets were then resuspended in a 7 ml volume, transferred into labeled 50 ml tubes and the total volume measured.

Frozen human fibroblast cells (Cambrex Corp., East Rutherford, N.J.) were thawed and plated in six-well plates at a density of ˜3.3×10⁴ cells/well. Human mesenchymal stem cells (Cambrex Corp., East Rutherford, N.J.), hMSC, were cultured in basal media supplemented with MSCGM bullet kit, glutamine and penicillin/streptomycin, and seeded in six-well plates at ˜3.3 ×10⁴ cells/well.

Bovine thrombin (BT)/CaCl₂ and autologous thrombin (AT) were prepared as previously described. BT and AT were added to PC in the ratio of 1:10 and 1:3, respectively.

In the fibroblast and hMSC growth study, clots were formed with a platelet concentrate using autologous thrombin and bovine thrombin as clot activators. Mixtures supplied to the cultured fibroblasts were incubated for three, five and seven days, while mixtures applied to hMSCs were incubated for two hours, and three and five days. The control consisted of an empty insert with media on top.

Fibroblasts were supplied with clot releasates through a platelet gel insert. hMSCs were supplied with clot releasates by centrifuging the test tubes containing the clot and applying the releasate directly onto the hMSCs.

Six sterile tubes were prepared for each mixture of:

1. Platelet concentrate and bovine thrombin;

2. Platelet concentrate and autologous thrombin; and

3. Platelet concentrate and autologous procoagulant.

2 ml of fresh media was added to each well of the plates. Membrane inserts with autologous thrombin, bovine thrombin or autologous procoagulant were prepared, allowed to clot, and placed on top of the wells containing the fibroblasts. The control was prepared with an empty insert and media on top. 1.5 ml of prewarmed media was then added to the top of each insert. The cultures were incubated at 37° C. with 5% CO₂ for 48 hours.

At the initiation of culture, one of each insert was removed and the cells were photographed. At day five, all inserts were removed and the cells photographed. The test was repeated, incubating all the inserts for three, five, or seven days, removing the inserts each time to examine and photograph the appearance of the cells.

Human Mesenchymal Stem Cell Culture

After seeding the plates, the cells were allowed to attach for approximately 2.5 hours. The PC-activator mixtures were incubated for two hours. The old media was aspirated from the cultures and fresh prewarmed media containing 10% of AT-PC releasate or 10% of BT-PC releasate was added directly to the cells. After 48 hours, the plates were examined and photographed. The test was repeated with three- and five-day releasates.

The human fibroblast cells incubated with clots prepared by AT or BT all looked healthy and growing well compared to the control cells (data not shown). The hMScs incubated with releasate from AT and BT looked healthy in appearance and were growing well as compared to the control cells.

Tissue culture studies were also performed using human umbilical vein endothelial cells (HUVECs) incubated with clot supernatant from both the AT and BT coagulants following mixing with a platelet concentrate. There was no change in cell morphology or density between controls or treatment groups with one-hour exposure to the test mixtures. Cultures left in contact with the BT supernatant for 24 hours demonstrated rounded cells with dense nuclei. Cell morphology of AT treated material was similar to controls.

Kinetics of Growth Factor Release

Platelets have a dual role in wound healing. They participate in the clotting process to achieve hemostasis and are a repository of growth factors which they release initiating the wound healing cascade. Though very potent, growth factors are rapidly degraded when injected or ingested. Controlled release, therefore, of growth factors from a platelet gel in a sustained fashion is an important aspect of the present invention in wound healing.

In order to release growth factors from the platelet alpha granules an activator must be used. The methods utilized in the following studies are identical to those used clinically to produce a platelet gel and closely mimic processes that occur in vivo. At the present time, the release of growth factors is initiated by mixing platelet concentrates with bovine thrombin/calcium chloride mixture. This study compared the kinetics of release by bovine thrombin, and autologous thrombin. The kinetics of release were determined by collecting the supernatant expressed from clots (platelet gel) formed by platelet concentrates that were exposed to the activators, bovine thrombin and autologous thrombin. The supernatant was collected after centrifugation at one, two, and four hours post preparation of platelet gel and thereafter daily for six days. The supernatant was stored at −80° C. until assayed. The level of growth factor (human platelet derived growth factor AB (PDGF-AB)) was measured by enzyme-linked immunosorbent assay technique (ELISA).

Platelet concentrate and platelet poor plasma were prepared as follows. Whole blood was obtained using a 60 ml syringe. Platelet concentrate (PC) and platelet poor plasma (PPP) was prepared using the SMARTPREP® 2 system in accordance with the instructions for use. The platelets were resuspended in 10 ml of plasma and the concentrate transferred into a labeled 50 ml vial. A 0.5 ml sample of PC and PPP were transferred into cryogenic vials for CBC analysis.

Bovine thrombin (BT) was prepared as described above and used at a dilution of 1,000 units/ml. BT is added to PC in the ratio of 1:10. Autologous thrombin (AT) was prepared as described above and is added to PC in the ratio of 1:3.

Clots were formed in PC using autologous thrombin and bovine thrombin as clot activators. Assays were performed on the supernatants expressed from clots that had been incubated for one, two, four hours and daily thereafter over a six-day period. All samples were tested for the levels of PDGF-AB growth factor. All measurements were performed in duplicate as follows.

1.0 ml of PC was delivered using calibrated pipettes into borosilicate glass culture tubes. The samples were then clotted using either BT added in the ratio of 1:10 or AT added in the ratio of 1:3. Once an activator is added to PC, the clots are incubated at room temperature for the designated time period. At the end of the incubation, the clots are centrifuged at 2500 rpm for 10 min in a Sorval RC3C centrifuge (Sorvall Instruments, Newton, Conn.) with a H4000 rotor. The supernatant was removed, its volume measured, and was transferred to a cryogenic vial, and stored at −80° C. until assayed.

The above procedure was performed at one, two and four hours and then daily over a 6-day period. Concentration of growth factors for all time points is calculated using the measurements obtained from an ELISA kit (R&D Systems, Minneapolis, Minn.) in accordance with the instructions for use.

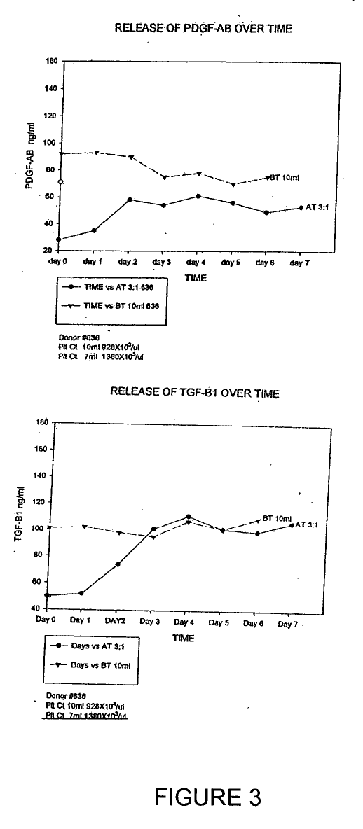

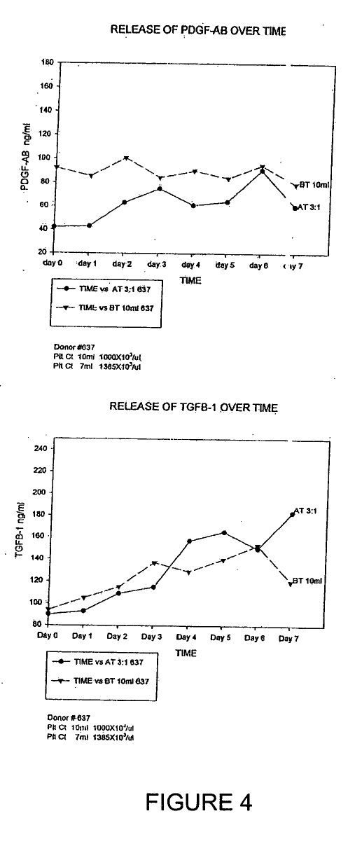

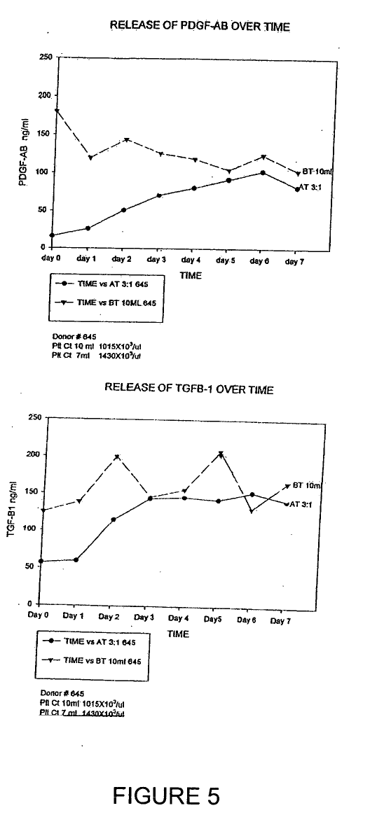

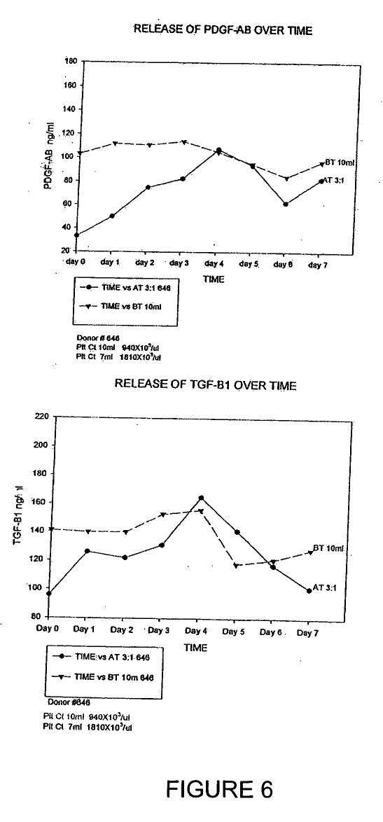

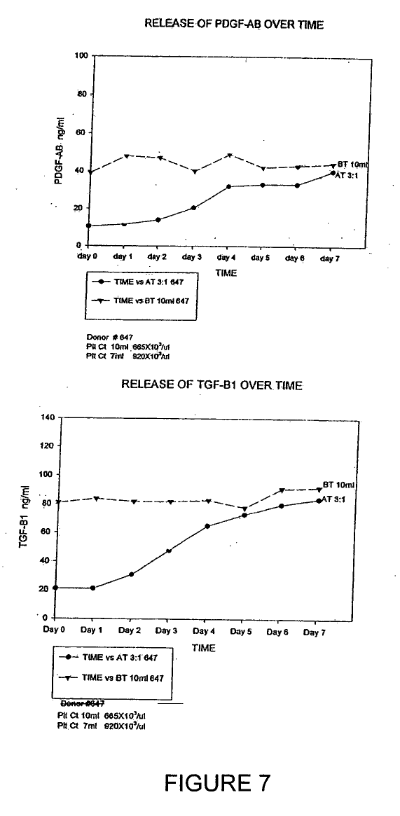

Platelet concentration, platelet yield and growth factor release is subject to individual variation as in all biological models. The following data show that some degree of variability exists in the release of growth factors from platelets by an activator. This variability is present whether the activator is bovine thrombin, ADP or autologous thrombin. FIGS. 3 through 7 show the in vitro growth factor release kinetics (PDGF-AB and TGF-β1) of five donor platelet concentrate blood samples activated with both bovine thrombin and autologous thrombin.

In this in vitro testing model, complete growth factor release with bovine thrombin occurs within the first four hours after clot formation, followed by a gradual level decrease over a seven-day period. With autologous thrombin, growth factor release increases gradually, achieving maximum levels after 48 to 72 hours. These maximum levels, depending upon growth factor, achieve minimally 80% of the growth factor level seen when bovine thrombin is used, or exceeds the maximum growth factor levels when bovine thrombin is used.

We have previously demonstrated that there is a direct correlation between platelet count and growth factor levels (8). In the present studies, platelet concentrates were suspended in 10 ml. Clinically, autologous thrombin will be used with platelet concentrates suspended in 7 ml. This will increase the growth factor levels released from these platelet concentrates by ˜30%.

It has been reported that the in vivo half-life of injected growth factor is minutes and therefore a sustained slow increase should be more beneficial (9). The release kinetics of growth factors by autologous thrombin support a slow sustained increase. Bovine thrombin releases the growth factors immediately, with no further increase over time.

The method of the present invention, therefore, provides a system that provides sustained release of growth factors that can be applied clinically. To determine the kinetics of release, growth factors were assayed by collecting the supernatants from clots formed by either BT or AT with the same platelet concentrate at set times after clotting. Application of BT to a platelet concentrate resulted in an immediate release of growth factors; there is no further increase throughout a five-day period of observation. The kinetics of growth factor release with AT demonstrated a 20-30% release within 4 hours of application with increasing release daily reaching a maximum by 5 days after application.

To facilitate easy employment of the disclosed method for the preparation of a fast-acting non-bovine coagulant, the various reagents and required medical implements may be packaged and provided as a self-contained kit.

One embodiment of a kit for use in practicing the method of the present invention may include:

a glass or plastic tube with stopper

a serum filter system, for example a serum separator device, blunt canula or pipette system suitable for aspirating supernatant from precipitate

a 3 ml syringe with blunt needle

a 10 ml syringe with blunt needle

a vial containing ACD or ACD/mannitol

a vial containing ETOH/CaCl₂

a TrayPak™ and instruction sheet

Thus, the present invention provides a method of preparing an autologous or homologous coagulant having the following characteristics:

1. It can be prepared from a whole blood sample

2. Incubation for the preparation process can be performed at room temperature.

3. The process can be prepared wither simultaneously with a platelet concentrate using the SMARTPREP® system or as a stand-alone procedure.

4. Incubation time for the whole blood and the precipitant is 45 minutes or less.

5. The resulting autologous coagulant preparation is of sufficient strength to clot a platelet concentrate or platelet poor plasma within a clinically acceptable period of time.

6. The autologous coagulant can be delivered in conjunction with platelet concentrate or platelet poor plasma by a variety of techniques or devices.

7. The autologous coagulant of the present invention can be applied directly to a wound bed.

### References

1. Ortel T L, Charles L A, Keller F G et al. Topical thrombin and acquired coagulation factor inhibitors: clinical spectrum and laboratory diagnosis. Am. J. Hematol. 1994; 45:128.

2. Fastenau D R and McIntyre. Immunochemical analysis of polyspecific antibodies in patients exposed to bovine fibrin sealant. Ann. Thorac. Surg. 2000; 69:1867.

3. Banninger H, Hardegger I, Tobler A et al. Fibrin glue in surgery: frequent development of inhibitors of bovine thrombin and human factor V. Br. J. Haematol. 1993; 85: 528.

4. Streiff M B and Ness P M. Acquired factor V inhibitors: a needless iatrogenic complication of bovine thrombin exposure. Transfusion 2002; 42:18.

5. Arnout J. The pathogenesis of the antiphospholipid syndrome: a hypothesis based on parallelism with heparin-induced thrombocytopenia. Thrombosis and Haemostasis 1996; 75:536.

6. Sands J J, Nudo S A, Ashford R G, et al. Antibodies to topical bovine thrombin correlate with access thrombosis. Am. J. Kid. Dis. 2000; 45:796.

7. Gottumukkala VNR, Sharma S K and Philip J. Assessing platelet and fibrinogen contribution to clot strength using modified thromboelastography in pregnant women. Anesth. Analg. 1999; 89:1453

8. Babbush C A, Kevy S V and Jacobson M S. An in vitro and in vivo evaluation of autologous platelet concentrate in oral reconstruction. Implant Dentistry 2003; 12:24.

9. Lee S J. Cytokine delivery and tissue engineering. Yonsei Medical Journal 2000; 41:704

10. Slater M, Patava J, Kingham K, et al. Involvement of platelets in stimulating osteogenic activity. J. Orthop. Res. 1995; 13:655

11. Haynesworth S E, Kadiyala S, Liang L N, et al. Chemotactic and mitogenic stimulation of human mesenchymal stem cells by platelet rich plasma suggests a mechanism for enhancement of bone repair. 48^{th} Annual Meeting Orthopedic Research Society, Dallas, Tex., 2002.

1. A method for the production of a coagulant from anticoagulated whole blood, comprising:
a) obtaining a volume of anticoagulated whole blood from a subject;
b) mixing said anticoagulated whole blood with a precipitating agent;
c) incubating the mixture of b) for a time sufficient to produce a cellular and specific plasma component precipitate and a supernatant;
d) separating the precipitate from the supernatant; and
e) recovering the supernatant wherein said supernatant is used as a coagulant.

2. The method of claim 1, wherein the volume of anticoagulated whole blood is between 8 to 10 ml.

3. The method of claim 1, wherein the whole blood is anticoagulated with an anticoagulant selected from the group consisting of ACD, ACD/mannitol, CPD, and EDTA.

4. The method of claim 3, wherein the whole blood is anticoagulated with acid-citrate-dextrose.

5. The method of claim 3, where the whole blood is anticoagulated with ACD/mannitol.

6. The method of claim 5, wherein the mannitol is present in a concentration of 7.5 mg/ml ACD.

7. The method of claim 1, wherein the precipitating agent is ethanol.

8. The method of claim 7, where said ethanol used is at a starting concentration of about 10% to 100%.

9. The method of claim 8, where said ethanol used is at a starting concentration of about 25% to 95%.

10. The method of claim 9, where said ethanol used is at a starting concentration of about 50% to 95%.

11. The method of claim 1, wherein the precipitating agent is a mixture of ethanol and calcium chloride.

12. The method of claim 1, wherein the incubation step requires less than 45 minutes.

13. The method of claim 1, wherein the incubation step requires less than 30 minutes.

14. The method of claim 1, wherein the coagulant prepared is autologous.

15. The method of claim 1, wherein the coagulant prepared is homologous.

16. The method of claim 1, wherein said separating step is accomplished by centrifuging the mixture.

17. The method of claim 1, wherein said separating step is accomplished by filtering the mixture.

18. The method of claim 1, wherein said separating step is accomplished by a combination of centrifugation and filtration of the mixture.

19. A kit for the preparation of a coagulant from anticoagulated whole blood, the kit comprising;
a) a tube with stopper;
b) a serum filter separator;
c) a 3 ml syringe with blunt needle;
d) a 10 ml syringe with blunt needle;
e) a vial containing ACD or ACD/mannitol;
f) a vial containing EtOH/CaCl₂; and
g) an instruction sheet.

20. A human blood fraction produced by the method of claim 1 comprising 80-90% of prothrombin-thrombin proteins, no detectable fibrinogen and 20-30% of baseline levels of ATIII, Protein C and Protein S.
